(19) United States
(12) Patent Application Publication
(10) Pub. No.: US 2003/0031526 A1
(43) Pub. Date: Feb. 13, 2003

(54) Lock washer

(76) Inventor: Anthony J. Grant, Whitefish Bay, WI (US)

Correspondence Address: PAUL F. DONOVAN, ILLINOIS TOOL WORKS INC., 3600 WEST LAKE AVENUE, GLENVIEW, IL, 60025, US

(21) Appl. No.: 10/213,622

(22) Filed: Aug. 6, 2002

Related U.S. Application Data
(60) Provisional application No. 60/310,566, filed on Aug. 7, 2001.

(51) Int. Cl. F16B 39/24

(52) U.S. Cl. 411/158

(57) ABSTRACT

The present invention provides a split helical lock washer with improved anti-rotation characteristics by providing surface texturing on at least one face surface of the washer.

### CROSS-REFERENCE TO RELATED APPLICATION

This application claims benefit to U.S. provisional application Serial No. 60/310,566, filed on Aug. 7, 2001.

### FIELD OF THE INVENTION

The present invention relates to lock washers for threaded fastener systems, and more specifically the invention pertains to lock washers of the split, helical type.

### BACKGROUND OF THE INVENTION

Maintaining the tightness of threaded fasteners presents difficulties, particularly when the apparatus upon which the fastener is secured or the fastener itself is subjected to frequent shaking or vibration, or periodic impacts. Such occurrences can result in the fastener loosening significantly in a relatively short period of time.

To overcome the problems created by a loosening threaded fastener, many different approaches have been used. Sprayed or painted coatings can be used to increase the grip between the fastener threaded shank and the nut used thereon. While such coatings can increase the holding performance of the threaded fastener, such coatings can make removal of a nut, or disengagement of other threaded fasteners difficult. For fasteners that may require periodic removal or loosening, this can be an undesirable side effect. Further, reapplication of such coatings on fasteners that are periodically removed and reattached is inconvenient, cumbersome, and may be unsightly. Coating accumulation over time can make the fastener difficult to use, requiring substitution of a new fastener, or cleaning of the old fastener. Similar approaches have been used to secure a bolt in a threaded hole of a work piece. Plastic cored “lock-nuts” have also been used to minimize the loosening that may occur. Many of these approaches are effective and expensive. Another drawback of each is that locknuts or thread coatings on a bolt provide resistance along the entire length of a bolt, as a nut is threaded thereon. Significant torque may be required to overcome this resistance for the entire length of a bolt along which a nut is threaded, making the fastening process slow.

It is also known to use different types of lock washers between the work piece and nut on a nut and bolt fastener, or between the head and work piece of a bolt secured in a threaded hole of the work piece. Lock washers compress between the surfaces, thereby increasing resistance to back-out of the fastener. Since a lock washer is relatively thin, it provides resistance only for a short axial distance of the fastener, allowing a nut, for example, to be spun on a bolt quickly, with additional resistance from the lock washer only for the final short axial distance as the nut is tightened. Upon removal of the nut, the lock washer provides resistance only for a short distance as the nut is broken free, and thereafter the nut can be spun off without resistance from the lock washer. As compared to other securing systems, lock washers are convenient, inexpensive and easy to use.

Two known designs for lock washers each include annular bodies with central openings. In one known design, often referred to as a “wave washer,” the annular body is continuous about its periphery, and has a wavy configuration between the top and bottom surfaces thereof. In another known design, often referred to as a “split washer,” the annular body is split and formed as a single helical wrap. Each has certain advantages functioning as an anti-rotation device to maintain the tightness of a threaded fastener. Although seemingly similar and simple, the conditions under which split helical washers and wave washers operate are quite different. Whereas wave washers are subjected to bending stress, a split helical washer is subjected to torsional stress.

Various types of surface treatments have been used on lock washers, some of which increase the friction between the lock washer and the head or nut of the fastener and the work piece against which the lock washer is compressed. For example, on wave washers it has been known to provide surface texturing in the way of dimpling. However, with known split helical washers, it has been widely accepted that the surfaces thereof should be smooth. Due to the torsional stresses imparted to a split helical washer, it has been accepted that stress risers caused by dimpling or other surface treating were detrimental, and should be avoided.

The manufacturing standard established by ASME B18.21.1-1999, Section 2.8 on Workmanship for split lock washers states that the flat surfaces, or faces, of a helical spring type lock washer should be free from all surface imperfections such as knurling, serrations, die marks, deep scratches, loose scale, burrs and other surface irregularities. Only moderate feed roll marks are permitted on the outer periphery of the washer.

What is needed is an improved lock washer functioning more effectively as an anti rotation device when used between the head of a threaded fastener and the work piece or between a nut and the work piece.

### SUMMARY OF THE INVENTION

The present invention provides a split helical washer with surface texturing on at least one face thereof.

In one form thereof, the invention provides a lock washer with a helical body having a first end and a second end in close proximity. The body has an inner edge, an outer edge, a first face surface and a second face surface, with a central opening defined by the inner edge between the first face surface and the second face surface. Surface texturing is provided on at least one of the first face surface and the second face surface.

In another form thereof, the invention provides an improvement for a split helical lock washer. The improvement provides surface texturing on at least one of the first and second face surfaces.

In still another form thereof, the invention provides a process for making a washer. The process includes providing a ribbon of washer material having first and second face surfaces; embossing at least one face surface of the ribbon; and forming the embossed ribbon into a split helical lock washer.

An advantage of the present invention is increasing the rotation resistance provided by a split helical washer.

Another advantage of the present invention is providing an improved lock washer that can be manufactured easily and at acceptable cost.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a schematic illustration of a manufacturing process for a split helical washer of the present invention;

FIG. 2 is a perspective view of the manufacture of a lock washer according to the present invention; and

FIG. 3 is a perspective view of a split helical washer of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of “including” and “comprising” and variations thereof herein is meant to encompass the items listed thereafter, and equivalents thereof, as well as additional items and equivalents thereof.

### DETAILED DESCRIPTION OF THE PREFERRED EMBODIMENT

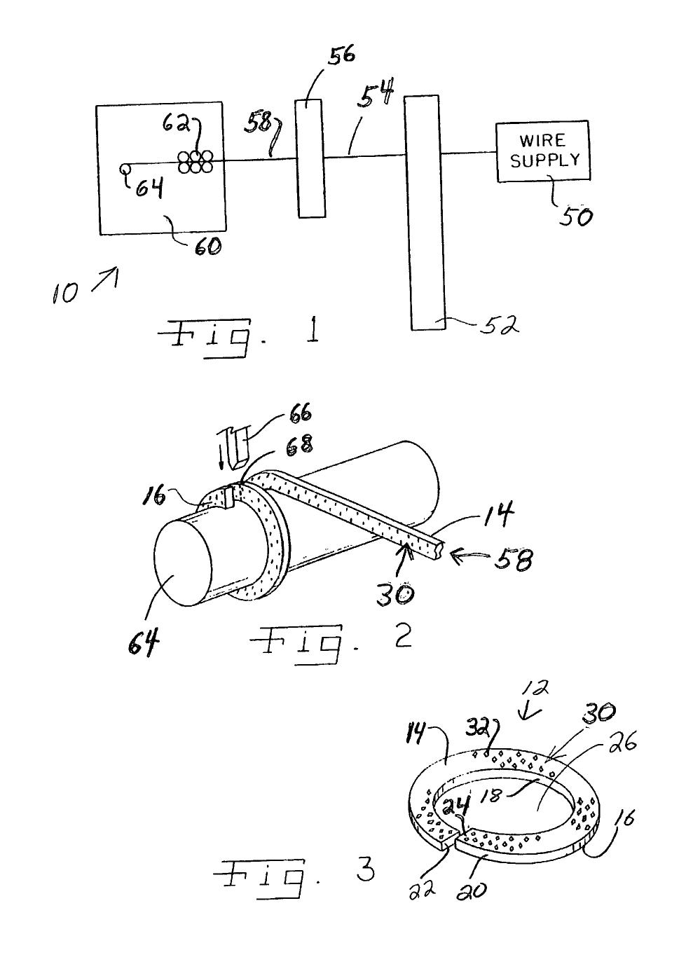

Referring now more specifically to the drawings, and to FIG. 1 in particular, a process 10 is illustrated for the manufacture of a split helical lock washer 12 (FIG. 3) according to the present invention.

A washer 12 is an essentially annular body having a first face 14, a second face 16, an inner edge 18 and an outer edge 20. Washer 12 further includes first and second ends 22 and 24, respectively, and a central opening 26. Washer 12 can be manufactured in different sizes, to be used with threaded fasteners of a wide variety of diameters. Thus, the diameter of central opening 26, the width of washer 12 between inner edge 18 and outer edge 20, and the thickness of washer 12 between first face 14 and second face 16 all can be varied as necessary for the specific application and use to which washer 12 will be placed. Further, washer 12 can be made of a wide variety of materials, commonly metal such as various steels, brass and the like. Platings or coatings can be applied to washer 12.

As thus far described, lock washer 12 is of known design; however, contrary to accepted split helical lock washer principals, the present invention includes texturing 30 provided on at least one of first face 14 and second face 16. Preferably, texturing 30 is present on both first face 14 and second face 16. Texturing 30 comprises a plurality of individual dimples 32, or other depressions in first face 14 and second face 16. For example, texturing 30 can comprise randomly positioned dimples or geometrically ordered depressions such as inverted pyramids pressed into each face. Texturing 30 provides frictional resistance between the surface of the washer and the material against which the washer rests, to resist vibration or other movement. The textured surface reduces the surface area coming into contact with the meeting material, thereby creating greater surface friction as compared to a standard, smooth, non-textured helical washer. The textured surface is configured in such a way as to not adversely mar or otherwise effect the mating material surface.

A textured lock washer according to the present invention can be created in various ways, with one such process 10 illustrated in FIG. 1. A supply of wire 50, such as a spool or coil of wire, is drawn through a first set of large rollers or other devices in a profiling apparatus 52. In profiling apparatus 52, the thickness of washer 12 between faces 14 and 16, and the width between inner edge 18 and outer edge 20 are established before final formation of the washer by rolling and forming the incoming wire. Profiling apparatus 52 can include a so-called “turks head” or rollers from Fenn Manufacturing of Connecticut, which transforms the circular cross-section of wire into the substantially rectangular cross section of a flattened ribbon 54 leaving profiling apparatus 52. Those skilled in the art will understand that ribbon 54 may actually have a trapezoidal cross-section.

The flattened ribbon 54 enters an inline embossing apparatus 56, in which the desired surface texturing 30 is applied. An embossing roller or rollers form a pattern of texturing 30 on one or both sides of ribbon 54, as the ribbon passes between cooperating nipped rollers. Embossing apparatus 56 can include a turks head having a second set of rollers with a surface pattern thereon. As ribbon 54 is drawn therethrough, the pattern from the rollers is impressed into the surface of ribbon 54. A ribbon-like, embossed strand 58 having the final surface texturing 30 thereon passes to a washer forming apparatus 60.

In washer forming apparatus 60, a plurality of rollers 62 or other devices are used to position and move the embossed strand 58. Rollers 62 can be used to draw the wire from wire supply 50 through profiling apparatus 52 and embossing apparatus 56. A coiling arbor 64 is provided, around which embossed strand 58 is wrapped, as a helix, and essentially on edge. The diameter of coiling arbor 64 controls the diameter of central opening 26 for each washer 12. The angle at which embossed strand 58 is wrapped on coiling arbor 64 can be varied, as desired. A cutoff apparatus 66 is provided to shear embossed strand 58 as it is wound around coiling arbor 64. While cutoff apparatus 66 has been depicted in the drawing in the nature of a knife, it should be understood that various types of rotating cutting heads or the like also can be used. Preferably, as indicated by dashed line 68, cutoff will occur at a location just prior to completion of a single wrap of embossed strand 58 around coiling arbor 64, as measured from the previous cutoff. By providing each washer 12 as slightly less than a full wrap, when washer 12 is compressed during use, first and second ends 22 and 24 thereof can be forced adjacent each other without overlapping.

In some washers 12 of the present invention, it may be desirable to provide patterned texturing 30 on first and second faces 14 and 16. For example, it may be advantageous in some uses of washer 12 for the area nearer inner edge 18 to include small diamond shaped dimples, and the area near outer edge 20 to include larger diamond shaped dimples. This can created from stretching and shaping of the material as the washer is being formed, even if similar sized dimples are originally provided in the embossed strand 58.

Performance tests have been conducted on textured lock washers as compared to non-textured washers. In one such test, a comparison of textured lock washers was made against conventional washers in an Unbrako testing machine. The test simulated the transverse movement in a bolted joint of a high strength hex head screw. The percentage of preload drop off against the number of load changes was plotted. The textured lock washers significantly outperformed standard washers. For a standard lock washer, less than twenty percent (20%) of the original preload remained after two-thousand vibration cycles, with most of the loss in preload occurring before one-thousand vibration cycles. When textured lock washers were tested, more than eighty percent (80%) of the original preload remained after five-thousand vibration cycles.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A lock washer comprising;
a helical body having a first end and a second end in close proximity, said body having an inner edge, an outer edge, a first face surface and a second face surface, with a central opening defined by said inner edge between said first face surface and said second face surface; and
surface texturing on at least one of said first face surface and said second face surface.

2. The lock washer of claim 1, said surface texturing provided on each of said first face surface and said second face surface.

3. The lock washer of claim 1, said first and second ends being spaced from each other.

4. The lock washer of claim 3, said surface texturing provided on each of said first face surface and said second face surface.

5. The lock washer of claim 4, said surface texturing being a pattern of dimples formed in each said first face surface and said second face surface.

6. The lock washer of claim 1, said surface texturing being a pattern of dimples formed in at least on of said first face surface and said second face surface.

7. In a split helical lock washer having first and second face surfaces, the improvement comprising surface texturing on at least one of said first and second face surfaces.

8. The improvement of claim 7, said surface texturing provided on each of said first face surface and said second face surface.

9. The improvement of claim 8, said surface texturing being a pattern of dimples formed in each said first face surface and said second face surface.

10. The improvement of claim 7, said surface texturing being a pattern of dimples formed in at least one of said first face surface and said second face surface.

12. A process for making a washer comprising, providing a ribbon of washer material, said ribbon having first and second face surfaces;
embossing at least one face surface of said ribbon; and
forming said embossed ribbon into a split helical lock washer.

13. The process of claim 12, including embossing both face surfaces of said ribbon.

14. The process of claim 13, including forming said washer by providing a coiling arbor and wrapping the embossed ribbon around the coiling arbor in a helical wrap.

15. The process of claim 14, including cutting said ribbon wrapped on said coiling arbor to form a helical washer body less than a complete helical wrap.
